(19) United States
(12) Patent Application Publication
(10) Pub. No.: US 2010/0296226 A1
(43) Pub. Date: Nov. 25, 2010

(54) ELECTRIC DOUBLE LAYER CAPACITOR

(75) Inventors: Youichi Nanba, Tokyo (JP); Masako Tanaka, Tokyo (JP); Takashi Mori, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/863,376

(22) PCT Filed: Jan. 15, 2009
(86) PCT No.: PCT/JP2009/050478

§ 371 Date: Jul. 27, 2010

(30) Foreign Application Priority Data
Jan. 17, 2008 (JP) 2008-007631

(51) Int. Cl. H01G 9/058; D01F 9/12; H01B 1/04

(52) U.S. Cl. 361/502; 423/447.2; 252/502; 977/734; 977/742

(57) ABSTRACT

Disclosed is an electric double layer capacitor having a positive polarizable electrode and a negative polarizable electrode, each of the positive and negative polarizable electrodes having a polarizable electrode layer, the positive polarizable electrode layer containing carbon fibers P and activated carbon P, the negative polarizable electrode layer containing carbon fibers N and activated carbon N, wherein at least one of the carbon fibers P and carbon fibers N has at least one peak in the range of 1 to 2 nm in a pore distribution determined by BJH analysis using a nitrogen adsorption method, and the sum total of BET specific surface areas of the activated carbon P and the carbon fibers P is larger than the sum total of BET specific surface areas of the activated carbon N and the carbon fibers N.

### TECHNICAL FIELD

The present invention relates to an electric double layer capacitor. More specifically, the present invention relates to an electric double layer capacitor that can be rapidly charged at a high current in wide temperature environments ranging from low to high temperatures, that ensures stable supply of electric power corresponding to an increase in current load at low temperatures, that does not induce heat generation, ignition, etc., and therefore has high safety, and that is applicable to non-contact charging systems etc.

### BACKGROUND ART

Electric double layer capacitors have the features that they have along life because they are not accompanied by chemical reactions, that are capable of rapid charging and discharging at a higher current when compared to secondary batteries, and that are resistant to over-charging and over-discharging.

Taking advantages of these features, electric double layer capacitors have mainly been used, for example, in memory backup power sources. Additionally, the application of electric double layer capacitors to power storage systems, engine assist systems of hybrid cars, etc., in combination with solar batteries or fuel cells, has been considered.

In recent years, the development of a technique of connecting electric double layer capacitors in parallel to secondary batteries that are used in portable electrical and electronic equipment such as mobile phones, cordless phones, electric shavers, electric toothbrushes, notebook computers, portable music players, etc., or a technique of completely replacing secondary batteries has been advanced. Furthermore, the development for use as non-contact charge type accumulators, which can be charged without bringing the terminal of the charger into contact with an electric drive system etc. for electrical and electronic equipment, electric vehicles, and hybrid electric vehicles, has been promoted.

However, conventional electric double layer capacitors have a low energy density, and it is thus difficult to achieve a high output capacitance. Particularly, the capacitance is low at low temperatures.

For these reasons, in order to achieve a high capacitance, for example, Patent Document 1 proposes an electric double layer capacitor in which activated carbon fibers used as a negative electrode have a specific surface area of 500 to 1500 m²/g, and activated carbon fibers used as a positive electrode have a specific surface area of 1000 to 2500 m²/g, the specific surface area of the activated carbon fibers used as the negative electrode is smaller than the specific surface area of the activated carbon fibers used as the positive electrode.

Patent Document 2 proposes an electric double layer capacitor in which the carbon material of one of a pair of polarizable electrodes contains microwave-activated fullerene or carbon nanotubes.

Patent Document 3 proposes an electric double layer capacitor in which a polarizable electrode mainly consisting of activated carbon contains very thin carbon fibers and/or very thin activated carbon fibers in an amount of 1 to 25% by mass. The very thin carbon fibers are made of a phenol resin.

Patent Document 4 proposes using activated carbon in the polarizable electrodes of an electric double layer capacitor, the activated carbon having the highest peak A of pore volume in the pore size range of 1.0 to 1.5 nm in the pore distribution, the value of the peak A being in the range of 0.012 to 0.050 cm³/g and being 2 to 32% of the total pore volume.

### PRIOR ART DOCUMENTS

Patent Document 1: Japanese Patent Laid-Open No. H08-107047

Patent Document 2: Japanese Patent Laid-Open No. 2006-310795

Patent Document 3: Japanese Patent Laid-Open No. 2006-245386

Patent Document 4: Japanese Patent Laid-Open No. 2007-186403

### DISCLOSURE OF INVENTION

### Problems to be Resolved by the Invention

However, the microwave-activated carbon nanotubes and fullerene used in the electric double layer capacitor proposed in Patent Document 2 have a high BET specific surface area of about 3500 m²/g, and it is therefore difficult to produce polarizable electrodes having a high electrode density. In the electric double layer capacitor proposed in Patent Document 3, the very thin carbon fibers made of a phenol resin have low electrical conductivity, and it is therefore difficult to sufficiently reduce the internal resistance or impedance by the carbon fiber network. Thus, charge-discharge characteristics are insufficient at rapid and high current. Moreover, as for the electric double layer capacitor proposed in Patent Document 1 or 4, it is confirmed that satisfactorily high output capacitance and low internal resistance are achieved at high temperatures; however, at low temperatures, the output capacitance does not reach a sufficiently high level, and the internal resistance is high. Hence, the application of the capacitors to portable electric and electronic equipment, electric vehicles, etc., which are used in wide temperature environments ranging from low to high temperatures, has necessitated further improvements in their characteristics.

An object of the present invention is to provide an electric double layer capacitor that can be rapidly charged at a high current in wide temperature environments ranging from low to high temperatures, that ensures stable supply of electric power corresponding to an increase in current load at low temperatures, that does not induce heat generation, ignition, etc., and therefore has high safety, and that is applicable to non-contact charging systems etc.

### Means of Solving the Problems

The inventors have earnestly proceeded with studies in order to achieve the above object and found that the use of carbon fibers that have at least one peak in the range of 1 to 2 nm of pore distribution determined by BJH analysis using a nitrogen adsorption method enables the production of an electric double layer capacitor that can be rapidly charged at a high current in wide temperature environments ranging from low to high temperatures, that ensures stable supply of electric power corresponding to an increase in current load at low temperatures, and that does not induce heat generation, ignition, etc., and therefore has high safety. The present invention has been accomplished upon further studies based on these findings.

More specifically, the present invention includes the following embodiments.

(1) An electric double layer capacitor comprising a positive polarizable electrode comprising a positive polarizable electrode layer containing carbon fibers P and activated carbon P, and a negative polarizable electrode comprising a negative polarizable electrode layer containing carbon fibers N and activated carbon N, wherein at least one of the carbon fibers P and carbon fibers N has at least one peak in the range of 1 to 2 nm in a pore distribution determined by BJH analysis using a nitrogen adsorption method; and the sum of BET specific surface areas of the activated carbon P and the carbon fibers P is larger than the sum of BET specific surface areas of the activated carbon N and the carbon fibers N.
(2) The electric double layer capacitor according to the above (1), wherein the BET specific surface area of the activated carbon P is larger than the BET specific surface area of the activated carbon N; and the BET specific surface area of the carbon fibers P is larger than the BET specific surface area of the carbon fibers N.
(3) The electric double layer capacitor according to the above (1) or (2), wherein the carbon fibers P have at least one peak in the range of 1 to 2 nm in a pore distribution determined by BJH analysis using a nitrogen adsorption method.
(4) The electric double layer capacitor according to any one of the above (1) to (3), wherein the carbon fibers P and/or carbon fibers N include those that adhere to each other at least at parts of their surfaces.
(5) The electric double layer capacitor according to any one of the above (1) to (4), wherein the carbon fibers P and/or carbon fibers N include those that have two or more hollow portions.
(6) The electric double layer capacitor according to any one of the above (1) to (5), wherein the carbon fibers P and/or carbon fibers N include those that have two or more hollow portions arranged in parallel along the length of the fibers.
(7) The electric double layer capacitor according to any one of the above (1) to (6), wherein the carbon fibers P and/or carbon fibers N are 1 to 2 in an R value of Raman spectrum.
(8) The electric double layer capacitor according to any one of the above (1) to (7), wherein the carbon fibers P and/or carbon fibers N have a BET specific surface area of 30 to 1000 m²/g, a mean fiber diameter of 1 to 500 nm, and an aspect ratio of 10 to 15000.
(9) The electric double layer capacitor according to any one of the above (1) to (8), wherein the sum of BET specific surface areas of the activated carbon P and the carbon fibers P is 1800 to 2600 m²/g; and the sum of BET specific surface areas of the activated carbon N and the carbon fibers N is 1500 to 2100 m²/g.
(10) The electric double layer capacitor according to any one of the above (1) to (9), wherein the activated carbon P and/or activated carbon N have the highest peak a of pore volume in a pore size range of 0.6 to 0.8 nm in a pore volume distribution determined by an HK analysis using Argon adsorption isotherm, the value of the peak a being in the range of 0.08 to 0.11 cm³/g and being 8 to 11% of the total pore volume; and the activated carbon P and/or activated carbon N have a BET specific surface area of 1700 to 2200 m²/g.
(11) The electric double layer capacitor according to any one of the above (1) to (10), wherein the positive and negative polarizable electrode layers each further contain conductive carbon and a binder.
(12) The electric double layer capacitor according to any one of the above (1) to (11), wherein the amount of the carbon fibers P is 0.1 to 20% by mass based on the amount of the activated carbon P; and the amount of the carbon fibers N is 0.1 to 20% by mass based on the amount of the activated carbon N.
(13) The electric double layer capacitor according to any one of the above (1) to (12), wherein the positive and negative polarizable electrodes each comprise a collector, a conductive adhesive layer, and the above-mentioned polarizable electrode layer, which are laminated, the conductive adhesive layer containing a compound having ion permeability and carbon fine particles.
(14) The electric double layer capacitor according to the above (13), wherein the compound having ion permeability is a cross-linked compound of polysaccharides.
(15) The electric double layer capacitor according to the above (13), wherein the compound having ion permeability is a compound of polysaccharides cross-linked with one or more cross-linking agents selected from the group consisting of acrylamide, acrylonitrile, chitosan pyrrolidone carboxylate salt, and hydroxypropylchitosan.
(16) The electric double layer capacitor according to the above (13), wherein the carbon fine particles are in the form of needles or bars.
(17) The electric double layer capacitor according to any one of the above (1) to (16), further comprising an electrolyte solution in which the polarizable electrodes are immersed, wherein the electrolyte solution contains a cation that is a quaternary ammonium ion and/or a quaternary imidazolium ion, the cation having a radius of 0.8 nm or less; and the electrolyte solution has a viscosity of 40 mPa·s or less at 25° C.±1° C.
(18) The electric double layer capacitor according to any one of the above (1) to (17), wherein the positive and negative polarizable electrodes are contained in a stainless steel or aluminum container that is sealed with a lid sealing material comprising at least one material selected from the group consisting of polyphenylene sulfide resin, polyether ketone resin, polyether ether ketone resin, polyethylene terephthalate resin, polybutylene terephthalate resin, and glass.
(19) The electric double layer capacitor according to any one of the above (1) to (18), wherein the positive and negative polarizable electrodes are respectively composed of two or more pairs of positive and negative polarizable electrode layers that are connected in parallel.
(20) Carbon fibers which have at least one peak in the range of 1 to 2 nm in a pore distribution determined by BJH analysis using a nitrogen adsorption method.
(21) The carbon fibers according to the above (20), which include those that adhere to each other at least at parts of their surfaces.
(22) The carbon fibers according to the above (20) or (21), which include those that have two or more hollow portions.
(23) The carbon fibers according to any one of the above (20) to (22), which include those that have two or more hollow portions arranged in parallel along the length of the fibers.
(24) The carbon fibers according to any one of the above (20) to (23), which have an R value of Raman spectrum of 1 to 2.
(25) The carbon fibers according to any one of the above (20) to (24), which have a BET specific surface area of 30 to 1000 m²/g, a mean fiber diameter of 1 to 500 nm, and an aspect ratio of 10 to 15000.
(26) A carbon composite comprising activated carbon and the carbon fibers according to any one of the above (20) to (25).
(27) A carbon composite comprising activated carbon and the carbon fibers according to any one of the above (20) to (25), wherein the activated carbon has the highest peak a of pore volume in a pore size range of 0.6 to 0.8 nm in a pore volume distribution determined by an HK analysis using Argon adsorption isotherm, the value of the peak a being in the range of 0.08 to 0.11 cm³/g and being 8 to 11% of the total pore volume; and the activated carbon has a BET specific surface area of 1700 to 2200 m²/g.
(28) A polarizable electrode comprising activated carbon and the carbon fibers according to any one of the above (20) to (25).
(29) A polarizable electrode comprising the carbon composite according to the above (26) or (27).
(30) An accumulator comprising the electric double layer capacitor according to any one of the above (1) to (19).
(31) The accumulator according to the above (30), further comprising a secondary battery.
(32) The accumulator according to the above (31), further comprising a temperature sensor and a means for controlling charging current on the basis of a detected value of the temperature sensor.
(33) The accumulator according to the above (32), wherein the temperature sensor is installed inside or outside the secondary battery.
(34) The accumulator according to any one of the above (30) to (33), further comprising a non-contact type power receiving means.
(35) The accumulator according to the above (34), wherein the non-contact type power receiving means receives power that is wirelessly transmitted by at least one system selected from the group consisting of an electromagnetic induction type power supply system, an electric wave receiving type power supply system, and a resonant type power supply system.
(36) An electrical or electronic equipment comprising the accumulator according to any one of the above (30) to (35).
(37) A vehicle comprising the accumulator according to any one of the above (30) to (35).
(38) A robot comprising the accumulator according to anyone of the above (30) to (35).
(39) A MEMS (Micro Electro Mechanical Systems) comprising the accumulator according to any one of the above (30) to (35).
(40) A toy comprising the accumulator according to any one of the above (30) to (35).
(41) A medical instrument comprising the accumulator according to any one of the above (30) to (35).
(42) A sensor comprising the accumulator according to any one of the above (30) to (35).
(43) A heating appliance comprising the accumulator according to any one of the above (30) to (35).
(44) A non-contact charging system comprising the accumulator according to the above (34) or (35) and a separated non-contact type power transmitter containing a non-contact type power transmitting means.
(45) The non-contact charging system according to the above (44), wherein the non-contact type power transmitting means wirelessly transmits power by at least one system selected from the group consisting of an electromagnetic induction type power supply system, an electric wave receiving type power supply system, and a resonant type power supply system.
(46) A charging system for electrical and electronic equipment, comprising the non-contact charging system according to the above (44) or (45).
(47) A charging system for a vehicle, comprising the non-contact charging system according to the above (44) or (45).
(48) An electrical or electronic equipment comprising the non-contact charging system according to the above (44) or (45).
(49) A vehicle comprising the non-contact charging system according to the above (44) or (45).

### ADVANTAGEOUS EFFECTS OF INVENTION

The electric double layer capacitor of the present invention can be rapidly charged at a high current in wide temperature environments ranging from low to high temperatures, ensures stable supply of electric power corresponding to an increase in current load at low temperatures, and does not induce heat generation, ignition, etc., and therefore has high safety.

The electric double layer capacitor of the present invention is suitably applicable to portable electrical and electronic equipment, electric vehicles, etc., which are used in wide temperature environments ranging from low to high temperatures. The capacitor is also applicable to non-contact charging systems etc.

### BRIEF DESCRIPTION OF DRAWINGS

FIG. 1 is a drawing showing a carbon fiber having tandemly arranged hollow portions used in the electric double layer capacitor of the present invention.

FIG. 2 is a drawing showing a carbon fiber having parallelly arranged hollow portions used in the electric double layer capacitor of the present invention.

FIG. 3 is a drawing illustrating a condition where carbon fibers adhere to each other.

FIG. 4 is a drawing showing the pore distributions of carbon fibers A and C used in the examples, determined by BJH analysis using a nitrogen adsorption method.

### DESCRIPTION OF EMBODIMENTS

The electric double layer capacitor of the present invention comprises a positive polarizable electrode and a negative polarizable electrode. A separator is generally disposed between the polarizable electrodes. The electric double layer capacitor further comprises an electrolyte solution in which the polarizable electrodes are immersed.

The polarizable electrode generally comprises a collector and a polarizable electrode layer formed on the surface of the collector. A conductive adhesive layer may be disposed between the collector and the polarizable electrode layer.

The positive polarizable electrode layer contains carbon fibers P, and the negative polarizable electrode layer contains carbon fibers N.

The carbon fibers P and/or carbon fibers N used in the polarizable electrode layers are thin carbon fibers that are suitably dispersed in the polarizable electrode layers. The carbon fibers have a mean fiber diameter of preferably 1 to 500 nm, and have an aspect ratio of preferably 10 to 15000. The carbon fibers may be branched carbon fibers, linear carbon fibers, or mixtures thereof.

The carbon fibers P and/or carbon fibers N have a fiber length that is preferably 0.5 to 100 times, more preferably 1 to 50 times, and particularly preferably 1 to 10 times the mean particle diameter of activated carbon, described later. When the length of the carbon fibers is too short, bridging between activated carbon particles might not be achieved, which might result in insufficient conductivity; whereas when the length of the carbon fibers is too long, the carbon fibers might not to enter into the spaces between the activated carbon particles, which may result in a reduction in strength of the polarizable electrodes. The mean particle diameter of activated carbon particles is an average weighted by volume measured by a laser diffraction scattering method.

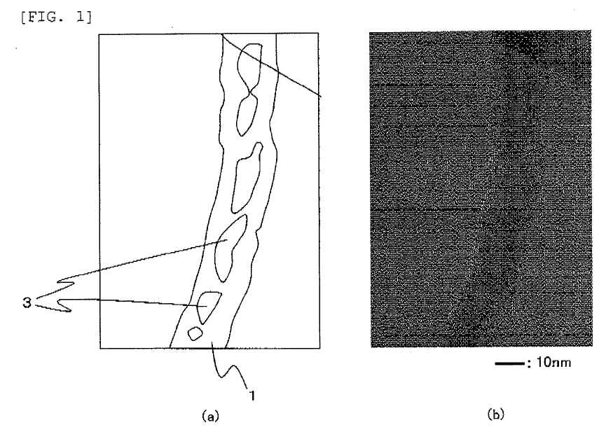

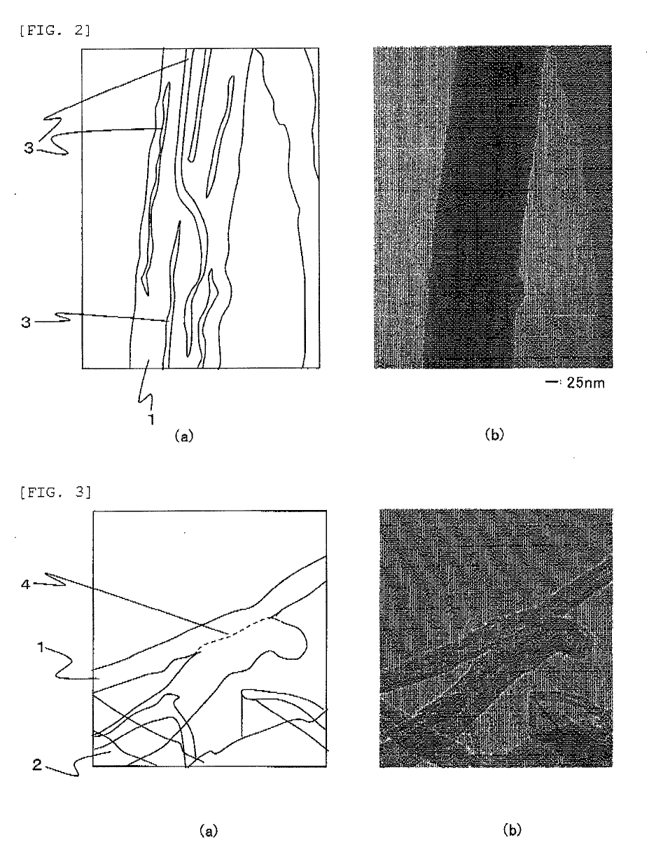

The carbon fibers P and/or carbon fibers N used in the present invention preferably include those that have hollow portions. It is preferable that one carbon fiber has two or more hollow portions. FIGS. 1 and 2 are drawings showing carbon fibers having hollow portions. FIG. 1(b) and FIG. 2(b) are drawings showing electron micrographs of carbon fibers. FIG. 1(a) and FIG. 2(a) are drawings showing only the outlines of the electron micrographs.

Such hollow portions may be present, for example, in the following manner: one continuous hollow portion may be present near the central axis of a fiber along the length of the fiber; two or more hollow portions may be present in parallel along the fiber length; or two or more hollow portions may be present tandemly along the fiber length. FIG. 1 shows the configuration in which two or more hollow portions are arranged tandemly along the fiber length. FIG. 2 shows the configuration in which two or more hollow portions are arranged in parallel along the fiber length. In the present invention, carbon fibers including those having two or more hollow portions arranged in parallel along the fiber length are preferred. The use of carbon fibers including those having two or more hollow portions arranged in parallel along the fiber length can further enhances the capacitance of the electric double layer capacitor. The presence of hollow portions can be confirmed by an electron microscope.

The BET specific surface area of the carbon fibers used in the present invention is preferably 30 to 1000 m²/g, and more preferably 50 to 500 m²/g. The size relationship between the BET specific surface area of the carbon fibers P and the BET specific surface area of the carbon fibers N is not limited; however, in the present invention, it may be necessary that the sum total of BET specific surface areas of the activated carbon P and the carbon fibers P be larger than the sum total of BET specific surface areas of the activated carbon N and the carbon fibers N; and therefore, the BET specific surface area of the carbon fibers P is preferably larger than the BET specific surface area of the carbon fibers N, more preferably larger than the BET specific surface area of the carbon fibers N by 10 m²/g or more, and particularly preferably larger than the BET specific surface area of the carbon fibers N by 100 m²/g or more. The BET specific surface area is determined by the BET method utilizing nitrogen absorption.

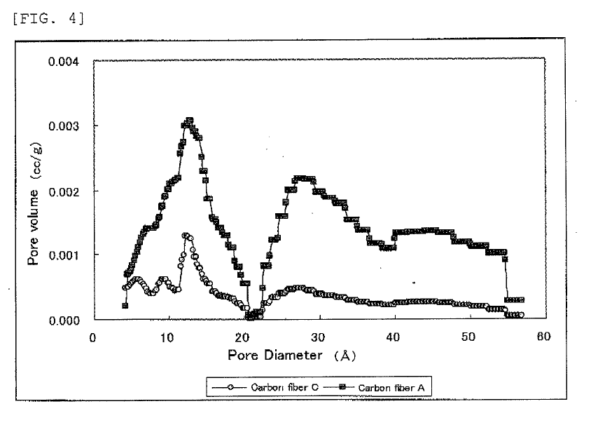

The carbon fibers P and/or carbon fibers N preferably include those that adhere to each other at least at parts of their surfaces. The term “adhere” means a condition where the surface of one carbon fiber is chemically coupled and integrated with the surface of another carbon fiber. Due to the presence of such an adhering portion, more conductive passes are constructed in the polarizable electrode layers, contributing a decrease in internal resistance and an improvement in high current and rapid charge characteristics of the electric double layer capacitor. FIG. 3 is a drawing illustrating a condition where carbon fibers adhere to each other. FIG. 3(b) is a drawing showing an electron micrograph of carbon fibers. FIG. 3(a) is a drawing showing only the outline of the electron micrograph. The carbon fiber 1 and carbon fiber 2 shown in FIG. 3(a) adhere to each other at an adhering portion 4. In the electron micrograph, a portion where the carbon fibers are overlapped with each other appears deeper in color than a portion where the carbon fibers are not overlapped with each other (see the fiber-overlapping portions shown in the lower left and lower right of FIG. 3(b)). In contrast, the adhering portion has almost no change in color in the electron micrograph.

The carbon fibers P and/or carbon fibers N preferably have an R values of Raman spectrum of 1 to 2, and more preferably 1.2 to 1.8. An R value is the ratio (I_{D}/I_{G}) of the peak intensity (I_{D}) at around 1360 cm⁻¹ and the peak intensity (I_{G}) at around 1580 cm⁻¹, measured by Raman spectroscopy. The R value indicates the degree of the growth of the graphite layer in the carbon fiber. As the degree of the growth of the graphite layer becomes higher, the R value decreases. When the R value is in the above range, both electrical conductivity and capacitance can be satisfied.

At least one of the carbon fibers P and carbon fibers N has at least one peak in the range of 1 to 2 nm in the pore distribution determined by BJH analysis using a nitrogen adsorption method. Preferably, the carbon fibers P have at least one peak in the range of 1 to 2 nm in the pore distribution determined by BJH analysis using a nitrogen adsorption method. The BJH analysis per se is known and can be carried out according to, for example, the method disclosed in J. Amer. Chem. Soc. 73. 373. (1951).

Although the carbon fibers P and carbon fibers N are not limited by their production method, carbon fibers produced by a vapor phase process are preferred in terms of conductivity.

The vapor phase process is such that a carbon source is thermally decomposed in a vapor phase, and the carbon is grown in fiber form using catalyst particles as the core.

Examples of carbon sources that can be used in the production of carbon fibers include methane, ethane, propane, butene, isobutene, butadiene, ethylene, propylene, acetylene, benzene, toluene, xylene, methanol, ethanol, propanol, naphthalene, anthracene, cyclopentane, cyclohexane, cumene, ethylbenzene, formaldehyde, acetaldehyde, acetone, and other organic compounds, carbon monoxide, and the like. These may be used singly or in combination of two or more. Additionally, white spirit, kerosene, etc. can also be used as carbon sources.

As the vapor phase in which the catalyst particles and carbon source are brought into contact with each other, generally, a reducing gas such as hydrogen gas is used. Although the amount of reducing gas can be suitably determined depending on the reaction condition, it is generally 1 to 70 parts by mole per 1 part by mole of carbon source. The fiber diameter of the carbon fibers can be arbitrarily controlled by adjusting the proportion of carbon source and reducing gas, or the residence time in the reactor. In addition to the reducing gas, an inert gas, such as nitrogen gas, may be used in combination.

As the catalyst particles, metal elementary substance or metal compound is used. Metal elements used in the catalyst are selected from Fe, Co, Ni, Sc, Ti, V, Cr, Mn, Cu, Y, Zr, Nb, Tc, Ru, Rh, Pd, Ag, lanthanoid, Hf, Ta, Re, Os, Ir, Pt, Au, W, Mo, etc., which may be suitably combined. These metal elements may be supported by a carrier. Examples of carriers include silica, alumina, magnesia, calcium carbonate, carbon powder, carbon black, graphitized carbon black, graphitized carbon black having a boron content of 0.1 to 5% by mass, and the like. A powder carrier is preferred. Although the temperature in the vapor growth of carbon is not limited, it is generally 550 to 750° C.

Further, the carbon fibers used in the present invention may be those produced by the above vapor phase process, and followed by baking at 1000 to 1500° C. Moreover, carbon fibers that are graphitized at a temperature of 2500° C. or higher after being baked at 1000 to 1500° C. can be used as the carbon fibers for the polarizable electrode layers.

The carbon fibers used in the present invention are preferably subjected to an activation treatment. The carbon fibers produced by the vapor phase process can be activated by heating in the presence of an alkali metal hydroxide. As a result of the activation treatment, carbon fibers having at least one peak in the range of 1 to 2 nm in the pore distribution determined by BJH analysis using a nitrogen adsorption method can easily be obtained. Moreover, carbon fibers adhering to each other (FIG. 3) or those having two or more hollow portions arranged in parallel along the fiber length (FIG. 2) can easily be obtained. The use of the activated carbon fibers is preferred because both conductivity and capacitance can be satisfied. Examples of alkali metal hydroxides include caustic soda, caustic potash, cesium hydroxide, and the like. The temperature of the activation treatment is generally 650 to 850° C., and preferably 700 to 750° C. The activation treatment is generally carried out in an inert gas atmosphere. Examples of inert gases include nitrogen gas, argon gas, and the like. Further, the activation treatment may be carried out by introducing water vapor, carbon dioxide gas, etc., if necessary. The activated carbon fibers may be washed with an acid or water, if necessary. The washing method is the same as that described in the explanation of a method of producing activated carbon, described later.

The positive polarizable electrode layer further contains activated carbon P, and the negative polarizable electrode layer further contains activated carbon N.

The amount of activated carbon P or activated carbon N is generally 60 to 95 parts by mass, and preferably 65 to 85 parts by mass, based on 100 parts by mass of polarizable electrode layer. The amount of activated carbon in the positive polarizable electrode layer and the amount of activated carbon in the negative polarizable electrode layer may be the same or different.

Activated carbon is a porous material composed of a large amount of carbon atom and other minor constituents, such as oxygen atom, hydrogen atom, alkaline earth metal element, and alkali metal element. The activated carbon used in the present invention is generally in the form of flakes, granules, and powders. The mean particle diameter of the activated carbon is generally 2 to 30 μm, and preferably 3 to 15 μm.

The activated carbon suitable for the present invention has the highest peak a of pore volume in the pore size range of 0.6 to 0.8 nm in the pore volume distribution determined by the HK analysis, that is Horvath-Kawazoe method, using Argon adsorption isotherm. The value of the peak a is preferably in the range of 0.08 to 0.11 cm³/g, and more preferably in the range of 0.09 to 0.11 cm³/g.

In the activated carbon suitable for the present invention, the value of the peak a is preferably 8 to 11%, and more preferably 9 to 11% of the total pore volume.

Moreover, the activated carbon suitable for the present invention preferably has a BET specific surface area of 1700 to 2200 m²/g, and more preferably 1800 to 2100 m²/g. When the BET specific surface area is within this range, the polarizable electrode layer can have a moderate filling density, and good charge-discharge characteristics can be achieved at low temperatures. The size relationship between the BET specific surface area of the activated carbon P and the BET specific surface area of the activated carbon N is not limited; however, in the present invention, it is necessary that the sum total of the BET specific surface areas of the activated carbon P and the carbon fibers P be larger than the sum total of the BET specific surface areas of the activated carbon N and the carbon fibers N; and therefore, the BET specific surface area of the activated carbon P is preferably larger than the BET specific surface area of the activated carbon N, and more preferably larger than the BET specific surface area of the activated carbon N by 100 m²/g or more.

The activated carbon is not limited by its production method, and activated carbon having the above-described features can be selected from those obtained by a known method.

As the starting material of the activated carbon, coconut shell, pitch, coal coke, petroleum coke, synthetic resins (e.g., vinyl chloride and polyethylene), and natural resins (e.g., cellulose) can be used.

Examples of the method of producing activated carbon suitable for the present invention are as follows:

(A) A method of producing activated carbon, comprising the steps of: carbonizing pitch in the presence of a chemical substance containing elements in the 2nd Group of the periodic table (so-called alkaline earth metals: Be, Mg, Ca, Sr, Ba, and Ra), elements in the 3rd to 11th Groups of the 4th Period of the periodic table (Sc, Ti, V, Cr, Mn, Fe, Co, Ni, and Cu), or an element in the 4th Group of the 5th Period of the periodic table (Zr), to obtain a graphitizable carbonized material; activating the graphitizable carbonized material in the presence of an alkali metal compound; and then washing the activated carbonized material.

(B) A method of producing activated carbon, comprising the steps of: carbonizing pitch to obtain a graphitizable carbonized material; mixing the carbonized material with a chemical substance containing element in the 2nd Group of the periodic table (so-called alkaline earth metal elements: Be, Mg, Ca, Sr, Ba, and Ra), elements in the 3rd to 11th Groups of the 4th Period of the periodic table (Sc, Ti, V, Cr, Mn, Fe, Co, Ni, and Cu), or an element in the 4th Group of the 5th Period of the periodic table (Zr), to obtain a mixture; activating the mixture in the presence of an alkali metal compound; and then washing the activated mixture.

The pitch used in the method of producing activated carbon preferably has a low softening point, more preferably a softening point of 100° C. or less, and particularly preferably a softening point of 60° C. to 90° C. Examples of the pitch include petroleum-derived pitch, coal-derived pitch, and organic solvent soluble constituents thereof.

As the chemical substance containing any of the elements in the 2nd Group of the periodic table, any of the elements in the 3rd to 11th Groups of the 4th Period of the periodic table, or the element in the 4th Group of the 5th Period of the periodic table, any of simple substances, inorganic compounds, and organic compounds can be used. Examples of inorganic compounds include oxide, hydroxide, chloride, bromide, iodide, fluoride, phosphate, carbonate, sulfide, sulfate, and nitrate. Examples of organic compounds include organic metal complexes containing acetylacetone, cyclopentadiene, or the like as a ligand.

The carbonization treatment is preferably conducted in the following manner: First, primary carbonization is carried out at a temperature of 400 to 700° C., and preferably 450 to 550° C. Subsequently, secondary carbonization is carried out at a temperature of 500 to 700° C., and preferably 540 to 670° C. The temperature of second carbonization is generally higher than that of primary carbonization. As a result of the carbonization treatment, the pitch undergoes a pyrolysis reaction. The pyrolysis reaction results in the elimination of gas and light distillates from the pitch, and the residue is polycondensed and finally solidified.

During the primary carbonization, the rate of temperature rise from room temperature (e.g., 0° C. in winter) to the primary carbonization temperature is preferably 3 to 10° C./hr, and more preferably 4 to 6° C./hr. The holding time at the maximum temperature is preferably 5 to 20 hours, and more preferably 8 to 12 hours.

During the secondary carbonization, the rate of temperature rise from the primary carbonization temperature to the secondary carbonization temperature is preferably 3 to 100° C./hr, and more preferably 4 to 60° C./hr. The holding time at the maximum temperature is preferably 0.1 to 8 hours, and more preferably 0.5 to 5 hours.

In the secondary carbonization, by rapidly raising the temperature, shortening the holding time at the maximum temperature, and slowly lowering the temperature, activated carbon suitably used in the present invention can be easily obtained. It is preferable to take 5 to 170 hours to reduce the temperature from the maximum temperature to room temperature.

The graphitizable carbonized material obtained by the above carbonization treatment is preferably pulverized into particles having a mean particle diameter of 1 to 30 μm before the subsequent activation treatment using an alkali metal compound. The pulverization method is not limited, and for example, jet mill, vibration mill, pulverizer, and other known pulverization methods can be used. When the graphitizable carbonized material is directly subjected to an activation treatment without pulverization, metal impurities in the particles may not be sufficiently removed by washing after the activation treatment, and the metal impurities trend to reduce durability of the activated carbon.

Although the alkali metal compound used in the activation treatment is not limited, alkali metal hydroxides, such as sodium hydroxide, potassium hydroxide, and cesium hydroxide, are preferred. The amount of alkali metal compound used is preferably 1.5 to 5.0 times, and more preferably 1.7 to 3.0 times the weight of carbonized material. The temperature of the activation treatment is generally 600 to 800° C., and preferably 700 to 760° C. The activation treatment is generally carried out in an inert gas atmosphere. Examples of inert gases include nitrogen gas, argon gas, and the like. Further, the activation treatment may be carried out by introducing water vapor, carbon dioxide gas, etc., if necessary.

Finally, the activated carbonized material is washed with water, acid, or the like. Examples of acids to be used for acid washing include mineral acids, such as sulfuric acid, phosphoric acid, hydrochloric acid, and nitric acid; organic acids, such as formic acid, acetic acid, and citric acid; etc. In terms of washing efficiency and a small amount of residue, hydrochloric acid and citric acid are preferred. The acid concentration is preferably 0.01 to 20N, and more preferably 0.1 to 1N. Washing may be conducted by adding an acid to the carbonized material and stirring the mixture; however, in order to enhance washing efficiency, boiling or heating at 50 to 90° C. is preferable. Moreover, the use of an ultrasonic washing machine is more effective. The washing time is 0.5 hour to 24 hours, and preferably 1 to 5 hours.

A carbon composite obtained by simply mixing the carbon fibers and the activated carbon may be used in the polarizable electrode layers; however, it is preferable to use a carbon composite that is obtained by mixing a graphitizable carbonized material obtained by carbonization of pitch with the carbon fibers, and subjecting the mixture to an activation treatment.

The mass ratio of carbon fibers and activated carbon used in the polarizable electrode layer is preferably 0.02 to 20% by mass, more preferably 0.1 to 20% by mass, and particularly preferably 0.5 to 10% by mass, as the mass of carbon fibers with respect to the mass of activated carbon. The use of the carbon fibers in this range of amount results in increasing capacitance (F/cm³) per volume of the electric double layer capacitor, ensuring stable quality. The mass ratio of carbon fibers and activated carbon used in the positive polarizable electrode layer and that in the negative polarizable electrode layer may be the same and different.

In the electric double layer capacitor of the present invention, the sum total of BET specific surface areas of the activated carbon P and the carbon fibers P is larger than the sum total of BET specific surface areas of the activated carbon N and the carbon fibers N, and preferably larger than the sum total of BET specific surface areas of the activated carbon N and the carbon fibers N by 100 m²/g or more. The range of the sum total of BET specific surface areas of the activated carbon P and the carbon fibers P is not limited; however, it is preferably 1800 to 2600 m²/g. The range of the sum total of BET specific surface areas of the activated carbon N and the carbon fibers N is not limited; however it is preferably 1500 to 2100 m²/g.

Although it is unclear why the electric double layer capacitor that can be rapidly charged at a high current in wide temperature environments ranging from low to high temperatures can be obtained by making the sum total of BET specific surface areas of the activated carbon P and the carbon fibers P larger than the sum total of BET specific surface areas of the activated carbon N and the carbon fibers N, it is presumed that a larger amount of electrolyte ions are adsorbed to the positive electrode, which has a larger BET specific surface area, rather than to the negative electrode, which has a smaller BET specific surface area, and the voltage of the positive electrode is thereby likely to be higher than the voltage of the negative electrode, preventing a decrease in capacitance and an increase in impedance in rapid charging at high current.

The polarizable electrode layer may further contain conductive carbon. Examples of conductive carbon include acetylene black, channel black, furnace black, and the like. Among these, Ketchen black (produced by Ketchen Black International), which is a kind of furnace black, is preferred, and particularly, Ketchen black EC300J and Ketchen black EC600JD (both are manufactured by Ketchen Black International) are preferred. The amount of conductive carbon is generally 0.1 to 20 parts by mass, and preferably 0.5 to 10 parts by mass, based on 100 parts by mass of polarizable electrode layer. The amount of conductive carbon in the positive polarizable electrode layer and the amount of conductive carbon in the negative polarizable electrode layer may be the same or different.

The polarizable electrode layer is generally produced in the following manner: a binder is added to a mixture of activated carbon, carbon fibers, and conductive carbon, which is optionally added, followed by kneading and rolling; a binder and optionally a solvent are added to a mixture of activated carbon, carbon fibers, and conductive carbon, which is optionally added, and the mixture is made into a slurry or paste, which is then applied to a collector; or non-carbonized resins are mixed into a mixture of activated carbon, carbon fibers, and conductive carbon, which is optionally added, followed by sintering.

Examples of binders include polytetrafluoroethylene (PTFE), polyvinylidene fluoride, acrylate-based rubber, butadiene-based rubber, and the like. Moreover, examples of solvents include organic solvents having a boiling point of 200° C. or less, such as toluene, xylene, benzene, and other hydrocarbons, acetone, methyl ethyl ketone, butyl methyl ketone, and other ketones, methanol, ethanol, butanol, and other alcohols, ethyl acetate, butyl acetate, and other esters, etc. Among these, toluene, acetone, ethanol, etc., are preferred.

Although the thickness of the polarizable electrode layer is not limited, it is generally 10 to 150 μm, and preferably 10 to 50 μm.

The collector that constitutes the polarizable electrode contains at least a conductive sheet. Examples of the conductive sheet include non-porous foils as well as punched metal foils, foils having net-like pores, etc. The conductive sheet is not limited as long as it is composed of conductive materials, and those made of conductive metals and those made of conductive resins can be mentioned. Particularly, conductive sheets made of aluminum or aluminum alloy are preferred. As aluminum foils, A1085, A3003, etc., are generally used.

The conductive sheet may be one that has a smooth surface; however, etched foils, the surfaces of which are roughened by, for example, electrical or chemical etching, are preferred.

Although the conductive sheet is not limited by its thickness, the thickness is generally preferably 5 μm to 100 μm. When the thickness is too thin, the mechanical strength might be insufficient, and the breaking of the conductive sheet easily may occur. In contrast, when the thickness is too thick, the capacitance per volume of the electric double layer capacitor is likely to be reduced.

It is preferable that a conductive adhesive layer is disposed between the collector and the polarizable electrode layer. A conductive adhesive layer suitable for the present invention is one that contains an ion-permeable compound and carbon fine particles.

Carbon fine particles are conductive fine particles containing carbon atom as the main constituent. Suitable examples of carbon fine particles include conductive carbon such as acetylene black, channel black, furnace black, Ketchen black, which is a kind of furnace black (produced by Ketchen Black International); carbon nanotubes, carbon nanofibers, vapor-grown carbon fibers; graphite, and the like.

Carbon fine particles having an electric resistance as powder of 1×10⁻¹ Ω·cm or less in 100% green compact are preferable. These carbon fine particles can be used singly or in combination of two or more.

Although the carbon fine particles are not limited by their particle size, the volume-weighted mean particle diameter is preferably 10 nm to 50 μm, and more preferably 10 nm to 100 nm.

The form of the carbon fine particles may be spherical; however, a needle-like or rod-like (anisotropic) form is preferred. Since anisotropic carbon fine particles have a large surface area per weight, and the areas of contact with the conductive sheet, polarizable electrode layer, etc., are large, even a small amount of the particles can increase conductivity between the collector and the polarizable electrode layer. Examples of anisotropic carbon fine particles include carbon nanotubes and carbon nanofibers. Carbon nanotubes and carbon nanofibers that have a fiber diameter of generally 0.001 to 0.5 μm, and preferably 0.003 to 0.2 μm, and have a fiber length of generally 1 to 100 μm, and preferably 1 to 30 μm, are preferred in terms of the enhancement of electrical conductivity and thermal conductivity. Moreover, conductive fine particles of metal carbide, metal nitride, etc., can be used in combination with carbon fine particles. Carbon fine particles in which the lattice spacing (d₀₀₂) determined by X-ray diffraction is 0.335 to 0.338 nm, and the crystallite thickness (Lc₀₀₂) is 50 to 80 nm are preferred in terms of electron conductivity.

The ion-permeable compound used in the present invention is not limited as long as it has the ability to allow permeation of ions.

The ion-permeable compounds having high ion conductivity are preferred. Specifically, the ion-permeable compounds having a fluorine ion conductivity of 1×10⁻² S/cm or more are suitably used. Moreover, the ion-permeable compounds having a number average molecular weight of 50,000 or less are preferred.

Preferred ion-permeable compounds used in the present invention are compounds that are not swellable in organic solvents. Moreover, preferred ion-permeable compound used in the present invention are compounds in which peeling does not occur in a friction and abrasion test using an organic solvent. The reason of this is because an organic solvent may be used in the electrolyte solution of the electric double layer capacitor, and it is therefore preferable that the membrane of the compound does not swell or dissolve in the electrolyte solution.

The swellability of the ion-permeable compound in an organic solvent is determined as follows: The membrane of the ion-permeable compound is immersed in an organic solvent at 30° C., which is used in the electrolyte solution, for 60 minutes, and whether the membrane swells is evaluated.

The friction and abrasion test using an organic solvent was conducted in such a manner that the membrane surface of the ion-permeable compound was rubbed ten times with a cloth into which the organic solvent used in the electrolyte solution soaks while applying 100-g force, and whether the membrane was peeled off is observed.

Suitable examples of the ion-permeable compounds include polysaccharides or cross-linked polysaccharides.

Polysaccharides are high molecular compounds in which a large number of monosaccharides (including substitutes and derivatives of monosaccharides) are polymerized by glycosidic linkages. Polysaccharides produce a large number of monosaccharides as a result of hydrolysis. Generally, those in which ten or more monosaccharides are polymerized are called polysaccharides. Polysaccharides having a substituent may be used, and examples thereof include polysaccharides in which an alcoholic hydroxyl group is substituted by an amino group (amino sugars), those in which an alcoholic hydroxyl group is substituted by carboxyl group or alkyl group, deacetylated polysaccharides, and the like. Such polysaccharides may be either of homopolysaccharides and heteropolysaccharides.

Specific examples of polysaccharides include agarose, amylose, amylopectin, araban, arabinan, arabinogalactan, alginic acid, inulin, carrageenan, galactan, galactosamine (chondrosamine), glucan, xylan, xyloglucan, carboxyalkyl chitin, chitin, glycogen, glucomannan, keratan sulfate, colominic acid, chondroitin sulfuric acid A, chondroitin sulfuric acid B, chondroitin sulfuric acid C, cellulose, dextran, starch, hyaluronic acid, fructan, pectic acid, pectic substance, heparan acid, heparin, hemicellulose, pentosan, β-1,4′-mannan, α-1,6′-mannan, lichenan, levan, lentinan, chitosan, and the like. Among these, chitin and chitosan are preferred.

Examples of cross-linking agents used to cross-link polysaccharides include acrylamide, acrylonitrile, chitosan pyrrolidone carboxylate salt, hydroxypropylchitosan, phthalic anhydride, maleic anhydride, trimellitic anhydride, pyromellitic anhydride, acid anhydride, and the like. Among these, one or more cross-linking agents selected from the group consisting of acrylamide, acrylonitrile, chitosan pyrrolidone carboxylate salt, and hydroxypropylchitosan are preferred.

More specific examples of ion-permeable compounds include polymers of cellulose cross-linked with acrylamide, polymer of cellulose cross-linked with chitosan pyrrolidone carboxylate salt, a chitosan cross-linked with a crosslinking agent, a chitin cross-linked with a crosslinking agent, polysaccharides cross-linked with an acrylic additive or acid anhydride, and the like. The ion-permeable compounds may be used singly or in combination of two or more.

The mass ratio of ion-permeable compound and carbon fine particles (=ion-permeable compound/carbon fine particles) in the conductive adhesive layer is preferably 20/80 to 99/1, and more preferably 40/60 to 90/10. The conductive adhesive layer may contain activated carbon, if necessary. The presence of activated carbon in the conductive adhesive layer increases the capacitance of the electric double layer capacitor. The activated carbon used in the conductive adhesive layer is not limited, and the same activated carbon as those used in the polarizable electrode layers can be used.

The conductive adhesive layer is not limited by its formation method. For example, the conductive adhesive layer is formed by dispersing or dissolving an ion-permeable compound, carbon fine particles, and optionally activated carbon, in a solvent to form a coating composition, and applying the coating composition to the conductive sheet, followed by drying. As the application method, a casting method, a bar coater method, a dipping method, a printing method, etc., can be mentioned. Among these methods, a bar coater method and a casting method are preferred in terms of easy control of the thickness of the coating.

The solvent used in the coating composition is not limited as long as it allows dispersion or dissolving of the ion-permeable compound and carbon fine particles. In order to adjust the viscosity of the coating composition, the solvent is preferably added so that the solids content of the coating composition is 10 to 100% by mass, and preferably 10 to 60% by mass. Almost all of the solvent is removed by drying after the application of the coating composition. After drying, it is preferable to thermally cure the coating. The ion-permeable compound composed of polysaccharides or cross-linked polysaccharides contains those that can be cured by heating. In order to further cure the conductive adhesive layer with heat, the above-described cross-linking agents can be added to the coating composition.

The thickness of the conductive adhesive layer is preferably 0.01 μm or more and 50 μm or less, and more preferably 0.1 μm or more and 10 μm or less. When the thickness is too thin, there may be a tendency that the desired effects (e.g., decrease in internal impedance) cannot be achieved. When the thickness is too thick, the capacitance per volume of the electric double layer capacitor is likely to be reduced.

A preferred conductive adhesive layer is one that can adhere closely to the conductive sheet and polarizable electrode layer, and does not peel off. Specifically, a conductive adhesive layer that does not peel off in a tape peeling test (JIS D0202-1988) is preferred.

As the electrolyte solution of the electric double layer capacitor, a known non-aqueous electrolyte solution or an aqueous electrolyte solution can be used. As non-aqueous electrolytes, polymer solid electrolytes, polymer gel electrolytes, and ionic liquid are available.

The viscosity of the electrolyte solution at 25° C.±1° C. is preferably 40 mPa·s or less, more preferably 30 mPa·s or less, even more preferably 10 mPa·s or less, and particularly preferably 5 mPa·s or less. When the viscosity at 25° C.±1° C. is higher than 40 mPa·s, high current and rapid charge characteristics tend to decrease in wide temperature environments ranging from low to high temperatures, particularly in low temperature regions.

The radius of the cation in the electrolyte solution is particularly preferably 0.8 nm or less. When the radius of the cation in the electrolyte solution is larger than 0.8 nm, the cation cannot move fast in the pores of the activated carbon with a pore diameter of 1.0 to 1.3 nm, and thereby rapid charge characteristics at high current tend to decrease.

In order to ensure high safety when the electric double layer capacitor generates heat, it is preferable to use a flame-retardant electrolyte solution. As a flame-retardant electrolyte solution, an ionic liquid is available. The ionic liquid is also called an ambient temperature molten salt or room temperature molten salt.

The ionic liquid is classified by a cation type into ammonium-based ionic liquids such as imidazolium salts and pyridinium salts, phosphonium-based ionic liquids, etc. By selecting the type of anion to be combined with these cations, ionic liquid having various structures can be selected.

Examples of cations include ammonium and its derivatives, imidazolium and its derivatives, pyridinium and its derivatives, pyrrolidinium and its derivatives, pyrrolinium and its derivatives, pyrazinium and its derivatives, pyrimidinium and its derivatives, triazonium and its derivatives, triazinium and its derivatives, triazine and its derivatives, quinolinium and its derivatives, isoquinolinium and its derivatives, indolinium and its derivatives, quinoxalinium and its derivatives, piperazinium and its derivatives, oxazolinium and its derivatives, thiazolinium and its derivatives, morpholinium and its derivatives, and piperazine and its derivatives. Among these, imidazolium derivatives, ammonium derivatives, and pyridinium derivatives are preferred.

The term “derivatives” herein used is intended to include those having substituents, such as aliphatic hydrocarbon groups, alicyclic hydrocarbon groups, aromatic hydrocarbon groups, carboxylic acid and ester groups, various ether groups, various acyl groups, and various amino groups (hydrogen atoms in the substituents may be substituted by fluorine atoms). These substituents are substituted at any positions of the cations described above. Moreover, cation components having a relatively small excluded volume are advantageously contained in the ionic liquid, and tetramethyl ammonium cation, tetraethyl ammonium cation, and 1-ethyl-3-methylimidazolium cation can be suitably used in the present invention.

Specific examples of cations include tetra ethylammonium (TEA: 0.7 nm), tetraethylmethylammonium (TEMA: 0.6 nm), diethylmethyl(2-methoxyethyl)ammonium (DEME: 0.8 nm), and other quaternary ammonium ions (cations expressed by R¹R²R³R⁴N⁺); ethyl methyl imidazolium (EMI: 0.3 nm), spiro-(1,1′)-bipyrrolidinium (SBP: 0.4 nm), 1-ethyl-2,3-dimethylimidazolium and other quaternary imidazolium ions, and quaternary phosphonium (cations expressed by R¹R²R³R⁴P⁺). The sign in each parenthesis is a code of cation, and the number is an ionic radius. R¹, R², R³, and R⁴ are independently an alkyl or allyl group having 1 to 10 carbon atoms. Among these, quaternary ammonium ions and/or quaternary imidazolium ions are preferred.

Examples of counter anions include BF₄⁻, PF₆⁻, ClO₄⁻, (CF₃SO₂)₂N⁻ (i.e., bis(trifluoromethylsulfonyl)imide)anion (TFSI)), RSO₃⁻, RSO₄²⁻ (wherein R is an aliphatic hydrocarbon group, an alicyclic hydrocarbon group, an aromatic hydrocarbon group, an ether group, an ester group, an acyl group, or the like, and the hydrogen atom may be substituted by a fluorine atom). Examples of RSO₃⁻ and RSO₄²⁻ include CF₃SO₃⁻, CHF₂CF₂CF₂CF₂CH₂OSO₃⁻, CHF₂CF₂CF₂CF₂CH₂SO₃⁻, ((C₂H₅)₄N)₂.SO₄²⁻, and ((CH₃(C₂H₅)₃N)₂.SO₄²⁻. Moreover, anion components having a relatively small excluded volume are advantageously used in the ionic liquid, and BF₄⁻ and CF₃SO₃⁻ can be suitably used in the present invention.

Specific examples of the ionic liquid that can be used in the present invention are as follows:

Imidazolium salt: 1-ethyl-3-methylimidazolium=chloride, 3-diethylimidazolium=bromide, 1-ethyl-imidazolium=tetrafluoroborate, 1-butyl-3-methyl-imidazolium=hexafluorophosphate, 1-butyl-3-methyl-imidazolium=hexafluorophosphate, 1-ethyl-3-methyl-imidazolium=trifluoromethanesulfonate, 1-ethyl-3-methylimidazolium=tosylate, 1-ethyl-3-methyl-imidazolium=benzenesulfonate, 1-ethyl-2,3-dimethyl-imidazolium=trifluoromethanesulfonate, 1-butyl-3-methylimidazolium=bis((trifluoromethyl)sulfonyl)amide, 1-isobutyl-3-methylimidazolium=bis((trifluoromethyl) sulfonyl)amide, 1-(2,2,2-trifluoroethyl)-3-methyl imidazolium=bis((trifluoromethyl)sulfonyl)amide, 1-butyl-3-methylimidazolium=heptafluorobutanoate, 1-butyl-3-methylimidazolium=2,2,3,3,4,4,5,5-octafluorop entanesulfate, 1-butyl-3-methylimidazolium=4,4,5,5,5-pentafluoro-1-pentanesulfate, 1-butyl-3-methylimidazolium=2,2,3,3,4,4,4-heptafluoro-1-butylsulf ate, and 1-butyl3-methylimidazolium=2,3,4, 5,6-pentafluorobenzylsulfate.

Pyridinium salt: N-butylpyridinium=chloride, N-butylpyridinium=hexafluorophosphate, pyridinium=tetrafluoroborate, N-ethylpyridinium=tosylate, N-butylpyridinium=benzenesulfonate, N-ethyl pyridinium=trifluoromethanesulfonate, N-butyl pyridinium=bis((trifluoromethyl)sulfonyl)amide, N-butyl pyridinium=2,2,3,3,4,4,5,5-octafluoropentanesulfate, and N-butylpyridinium=2,3,4,5,6-pentafluorobenzylsulfate.

Pyrrolidinium salt: 2-methylpyrrolidinium=chloride, 3-ethylpyrrolidinium=hexafluorophosphate, 2-methylpyrrolidinium=tetrafluoroborate, 3-ethyl pyrrolidinium=tosylate, pyrrolidinium=benzene sulfonate, 2-methylpyrrolidinium=trifluoro methanesulfonate, 3-butylpyrrolidinium=bis((trifluoro methyl)sulfonyl)amide, 2-butylpyrrolidinium=2,2,3,3, 4,4,5,5-octafluoropentanesulfate, and 2-methyl-pyrrolidinium=2,3,4,5,6-pentafluorobenzylsulfate.

Ammonium salt: trimethylbutylammonium=chloride, trimethylbutylammonium=hexafluorophosphate, trimethyl-butylammonium=tetrafluoroborate, triethylbutyl-ammonium=tosylate, tetrabutylammonium=benzenesulfonate, trimethylethylammonium=trifluoro methanesulfonate, tetramethylammonium=bis((trifluoro methyl)sulfonyl)amide, trimethyloctylammonium=2,2,3,3, 4,4,5,5-octafluoropentanesulfate, tetraethylammonium=2,2,3,3,4,4,5,5-octafluoropentanesulfate, and trimethyl-butylammonium=2,3,4,5,6-pentafluorobenzylsulfate.

Triazinium salt: 1,3-diethyl-5-methyltriazinium=chloride, 1,3-diethyl-5-butyltriazinium=hexafluoro phosphate, 1,3-dimethyl-5-ethyltriazinium=tetrafluoro borate, 1,3-diethyl-5-methyltriazinium=tosylate, 1,3-diethyl-5-butyltriazinium=benzenesulfonate, 1,3-diethyl-5-methyltriazinium=trifluoromethanesulfonate, 1,3,5-tributyltriazinium=bis((trifluoromethyl)sulfonyl) amide, 1,3-dibutyl-methyltriazinium=2,2,3,3, 4,4,5,5-octafluoropentanesulfate, and 1,3-diethyl-5-methyltriazinium=2,3,4,5,6-pentafluorobenzylsulfate.

Since an ionic liquid generally has a high viscosity, the electrical conductivity of the ionic liquid alone may not be sufficient. For this reason, the ionic liquid is generally used in the form of a mixture with a non-aqueous solvent. Mixing the ionic liquid with a non-aqueous solvent results in an electrolyte solution that is less likely to coagulate even at a low temperature, that has high electrical conductivity, and that is fire retardant. The use of such an electrolyte solution results in an improvement in capacitance and charge-discharge rate of the electric double layer capacitor, and a reduction in flammability, thereby decreasing risks of ignition, etc.

The non-aqueous solvents used in the present invention is not limited as long as it can be mixed with ionic liquids; however, those that can produce a mixture having a relatively high content of ionic liquid and a low viscosity are preferred. Moreover, in terms of voltage resistance, it is preferable to use non-aqueous solvents that have sufficient potential window. For example, ethylene carbonate, propylene carbonate, and other carbonate-based non-aqueous solvents, acetonitrile, γ-butyl lactone, etc., can be mentioned.

In the present invention, the ionic liquids or non-aqueous solvents can be used in combination of two or more.

In the electrolyte solution preferably used in the present invention, the amount of ionic liquid is preferably more than 0% by mass and less than 80% by mass, and more preferably 30 to 70% by mass, based on the total mass of non-aqueous solvent and ionic liquid.

The proportion (volume ratio) of the ionic liquid and non-aqueous solvent may be in the range where the amount of ionic liquid is within ±50% from the mixing ratio at which the mixture of the ionic liquid and non-aqueous solvent produces an electrolyte solution with the highest electrical conductivity. Mixing the ionic liquid and the non-aqueous solvent at any proportion within this range can produce an electrolyte solution with sufficient electrical conductivity, which can suitably be used for the purpose of the present invention. In terms of the improvement in capacitance and charge-discharge rate, the proportion (volume ratio) is more preferably in the range where the amount of ionic liquid is within ±20% from the mixing ratio at which the highest electrical conductivity is achieved, and particularly preferably in the range where the amount of ionic liquid is within ±10% from the mixing ratio at which the highest electrical conductivity is achieved. Specifically, a preferable mixing ratio of ionic liquid and non-aqueous solvent is in the range of 1:5 to 5:1 (volume ratio).

The separator disposed between the polarizable electrodes may be a porous separator, through which ions can penetrate. For example, a microporous polyethylene film, microporous polypropylene film, ethylene non-woven fabric, polypropylene non-woven fabric, glass fiber-mixed non-woven fabric, etc., can preferably be used.

The electric double layer capacitor of the present invention may have any of the following structures: a coin type in which a separator is placed between a pair of polarizable electrodes, and they are accommodated in a metal case together with an electrolyte solution; a wound type in which a pair of electrodes are wound via a separator; and a laminated type in which a plurality of separators and electrodes are laminated. The electric double layer capacitor is preferably sealed with a stainless steel or aluminum container. Moreover, in terms of preventing the electrolyte solution from vaporizing during heat generation, and for the purpose of ensuring high temperature stability of the electric double layer capacitor, it is preferable to use insulating materials that have high heat resistance in the sealing part of the container. Particularly, it is preferable to use at least one selected from the group consisting of polyphenylene sulfide resin, polyether ketone resin, polyether ether ketone resin, polyethylene terephthalate resin, polybutylene terephthalate resin, and glass. Moreover, the positive and negative polarizable electrodes may be composed of two or more pairs of positive and negative polarizable electrode layers that are connected in parallel respectively.

The electric double layer capacitor of the present invention is preferably assembled in a dehumidification or inert gas atmosphere. It is also preferable to dry the components to be assembled in advance. As the method of drying or dehydrating the pellet, sheet, and other components, methods that are generally adopted can be utilized. Particularly, hot air, vacuum, infrared rays, far-infrared rays, electron rays, and low moist air are preferably used singly or in combination. The temperature is preferably in the range of 80 to 350° C., and particularly preferably 100 to 250° C. The moisture content is preferably 2000 ppm or less in the entire cell, and the moisture content of each of the polarizable electrode and electrolyte is preferably 50 ppm or less in terms of the improvement in charge-discharge cycle characteristics.

The electric double layer capacitor of the present invention can be applied to an accumulator of a power supply system. The power supply system can be applied to power supply systems for vehicles such as automobiles and railroad; power supply systems for ships; power supply systems for aircrafts; power supply systems for portable electronic equipment such as mobile phones, personal digital assistants, and portable electronic calculators; power supply systems for office equipment; power supply systems for power generation systems such as solar battery power generation systems, wind power generation systems, and fuel cell power generation systems; and the like. Moreover, the electric double layer capacitor of the present invention is suitable for a non-contact charge type accumulator.

The accumulator of the present invention comprises the above electric double layer capacitor. Moreover, the non-contact charge type accumulator of the present invention comprises a non-contact type power receiving means and the above electric double layer capacitor.

The non-contact type power receiving means receives wirelessly transmitted power, and preferably receives power that is wirelessly transmitted by at least one system selected from the group consisting of an electromagnetic induction type power supply system, an electric wave receiving type power supply system, and a resonant type power supply system. For example, a non-contact type power receiving means in the electromagnetic induction type power supply system comprises a power receiving coil, and optionally a resonant capacitor and a rectifier circuit; one in the electric wave receiving type power supply system comprises an antenna, a resonant circuit, and a rectifier circuit; and one in the resonant type power supply system comprises an antenna equipped with LC resonator or an antenna containing dielectrics that have high permittivity and a low dielectric loss.

It is preferable that the accumulator of the present invention further comprises a secondary battery. Examples of such secondary batteries include lithium ion batteries, nickel-hydrogen batteries, nickel-cadmium batteries, and the like. Among these, lithium ion batteries are preferred.

The secondary battery is preferably connected in parallel to the electric double layer capacitor. During rapid charging, when the power received by the non-contact type power receiving means etc. from the non-contact type power transmitting means is directly supplied to the secondary battery for charging, a large load is applied on the secondary battery, and thereby the secondary battery may generate heat and ignite. When the secondary battery is connected in parallel to the electric double layer capacitor, the electric double layer capacitor receives part of high current during rapid charging, and thereby the load applied on the secondary battery can be reduced, so that troubles such as heat generation and ignition can be prevented.

Moreover, when high current supply is required in, for example, pulse oscillation, both the secondary battery and electric double layer capacitor can supply power, and thereby, large voltage drop of the secondary battery can be prevented. Further, in the case that the power supply rate is reduced because of decreased capacitance of the secondary battery etc., the electric double layer capacitor of the present invention can keep supplying power because it has high capacitance. Thus, the uptime of portable electronic devices etc. can be greatly increased.

It is preferable that the accumulator of the present invention further comprises a temperature sensor and a means for controlling charging current on the basis of the detected value of the temperature sensor. As a temperature sensor, not only a thermistor but also a thermocouple, a resistance thermometer, and the like can be employed.

The temperature sensor is preferably installed inside or outside the secondary battery. The temperature sensor detects the temperature of the accumulator, particularly the temperature of the secondary battery; the detected temperature value is transmitted to the means for controlling charging current; and the charging current control means adjusts the level of charging current transmitted from the non-contact type power receiving means etc. to the secondary battery or electric double layer capacitor. For example, when the temperature of the secondary battery or electric double layer capacitor becomes higher than the threshold level because of high current during rapid charging and the incorporation of foreign substances such as Ni, the charging current transmitted from the non-contact type power receiving means etc. can be reduced or intercepted by the charging current control means. Consequently, the accumulator can be charged at an optimum charging current while preventing ignition etc., and the charging time can be reduced.

The non-contact charging system of the present invention comprises the non-contact charge type accumulator of the present invention and a separated non-contact type power transmitter containing a non-contact type power transmitting means. The non-contact charge type accumulator and the non-contact type power transmitter are separated bodies, which are present independently from each other.

In the non-contact charging system of the present invention, the non-contact type power transmitter wirelessly transmits power, and the power is received by the non-contact charge type accumulator of the present invention, and thus the power can be stored. For example, a device embedded with the non-contact charge type accumulator and a device embedded with the non-contact type power transmitter enter in the distance that allows wireless transmission, power is wirelessly transmitted from the non-contact type power transmitting means, which constitutes the non-contact type power transmitter, to the non-contact receiving means, and thus supplied to the non-contact charge type accumulator.

The non-contact type power transmitter in the non-contact charging system comprises a non-contact type power transmitting means. The non-contact type power transmitting means wirelessly transmits power. A preferred system to wirelessly transmit power is at least one selected from the group consisting of an electromagnetic induction type power supply system, an electric wave receiving type power supply system, and a resonant type power supply system. The distance that allows wireless transmission varies depending on the type of power supply system. For example, it is said that the distance is about several centimeters in the electromagnetic induction type power supply system; it is several centimeters to several ten meters in the electric wave receiving type power supply system; and it is several meters to several ten meters in the resonant type power supply system; however, the distance is not limited thereto. The output power that can be wirelessly transmitted is not limited, although it varies depending on the type of power supply system.

Since the accumulator of the present invention can construct a non-contact charging system that can be rapidly charged at a high current, that ensures stable supply of electric power corresponding to an increase in current load at low temperatures, and that does not induce heat generation, ignition, etc., and therefore has high safety, the accumulator can be applied to various applications.

The accumulator of the present invention can be used as a power supply for various equipment such as a personal computer, keyboard, mouse, external hard disk drive, mobile phone, personal digital assistant (PDA), electric shaver, electric toothbrush, electric vehicle, hybrid electric vehicle (HEV), robot, MEMS (Micro Electro Mechanical Systems), go-cart, portable electric equipment, video game instrument, various toys, cosmetics and makeup instrument, lighting fixture, medical equipment, sensor, heating appliance, portable music player, video player (e.g., DVD player), digital recorder, radio receiver, television receiver, liquid crystal display, organic EL display, digital camera, digital movie, vacuum cleaner, hearing aid, pacemaker, wireless tag, active sensor, wrist watch, and the like.

According to the non-contact charging system of the present invention, one or more non-contact type power transmitters are disposed at various places indoor and outdoor environments (e.g., a railway station, bus stop, waiting room of an airport, waiting room of a harbor for ships, stand, teahouse, restaurant, parking lot, garage, bathroom, smoking room, desk, wall, floor, ceiling, column, road, etc.). When devices embedded with the non-contact charge type accumulator of the present invention enter into the range of wireless transmission of one of the non-contact type power transmitters, power can be supplied from the non-contact type power transmitter to the non-contact charge type accumulator. As a result, the electric double layer capacitor and/or secondary battery in the non-contact charge type accumulator can be charged every time the non-contact charge type accumulator enters into the range of wireless transmission of the non-contact type power transmitter, and thus the power can be stored. Consequently, lack of power less often causes electrical and electronic equipment to run down or electric vehicles etc. to be disabled. Moreover, since it is not necessary, as in plug-in systems, to connect the terminal to the contact point of a contact type charger, a failure to charge etc. is prevented. Furthermore, since there is no exposed metal contact point, frequency of troubles, such as earth leakage and short circuit, can be reduced.

Moreover, electrical and electronic equipment or a vehicle comprising the non-contact charging system (i.e., electrical and electronic equipment or a vehicle comprising both non-contact charge type accumulator and non-contact type power transmitter) can wirelessly transmit power to each other. For example, according to a mobile phone or electric vehicle comprising the non-contact charging system, in the case that the mobile phone or electric vehicle run out of power and therefore does not work, power can be supplied from other mobile phone or electric vehicle comprising the non-contact charging system, which still has power, to save the equipment or vehicle that has run out of power.

### EXAMPLES

The present invention is described in detail below with reference to examples and comparative examples; however, the present invention is not limited thereto.

Activated carbon A: volume-weighted mean particle diameter: 4.8 μm; having the highest peak a of pore volume in the pore size range of 0.6 to 0.8 nm in the pore volume distribution determined by the HK analysis using Argon adsorption isotherm; the value of Peak a: 0.11 cm³/g, which is 8% of the total pore volume; BET specific surface area: 2009 m²/g.

Activated carbon B: volume-weighted mean particle diameter: 5.6 μm; having the highest peak a of pore volume in the pore size range of 0.6 to 0.8 nm in the pore volume distribution determined by the HK analysis using Argon adsorption isotherm; the value of Peak a: 0.08 cm³/g, which is 9% of the total pore volume; BET specific surface area: 1845 m²/g.

Activated carbon C: volume-weighted mean particle diameter: 15.7 μm; not having the highest peak a of pore volume in the pore size range of 0.6 to 0.8 nm in the pore volume distribution determined by the HK analysis using Argon adsorption isotherm; BET specific surface area: 2064 m²/g

Activated carbon D: volume-weighted mean particle diameter: 6.8 μm; not having the highest peak a of pore volume in the pore size range of 0.6 to 0.8 nm in the pore volume distribution determined by the HK analysis using Argon adsorption isotherm; BET specific surface area: 1755 m²/g

Activated carbon E: volume-weighted mean particle diameter: 8.5 μm; not having the highest peak a of pore volume in the pore size range of 0.6 to 0.8 nm in the pore volume distribution determined by the HK analysis using Argon adsorption isotherm; BET specific surface area: 2206 m²/g

The pore volume distribution and BET specific surface area of the activated carbon were measured using NOVA 1200 (manufactured by Yuasa Ionics Inc.).

The mean particle diameter of the activated carbon was measured using MICROTRAC HRA (model: 9320-X100; manufactured by Honeywell International Inc.).

### Example 1

### Carbon Fibers A

Vapor-grown carbon fibers produced by a standard method (mean fiber diameter: about 20 nm, length: about 10000 nm; manufactured by Showa Denko K.K.) were mixed with potassium hydroxide (purity: 95.0%; manufactured by Toagosei Co., Ltd.) in an amount 4.0 times by mass the amount of fibers, distilled water and ethanol. The mixture was put in a nickel container, and the container was placed in a batch type electric furnace. In the N₂ atmosphere, the temperature was increased to 400° C. at a heating rate of 5° C./min. and maintained for 30 minutes. Subsequently, the temperature was increased to 750° C. and maintained for 15 minutes. Finally, the container was allowed to stand in the furnace until the temperature was 100° C. or less. The container was taken out from the furnace into the air, and 1N-hydrochloric acid was added to the reaction product for neutralization. The neutralized product was washed twice with boiling 0.1N-hydrochloric acid to remove metal impurities. Subsequently, the resultant was washed twice with boiling distilled water to remove the remaining Cl and metal impurities. Finally, hot-air drying was carried out at 110° C., thereby obtaining carbon fibers A.

### Example 2

### Carbon Fibers C

Vapor-grown carbon fibers produced by a standard method (mean fiber diameter: about 150 nm, length: about 9000 nm; manufactured by Showa Denko K.K.) were baked at 1000° C. The carbon fibers after baking had a mean fiber diameter of about 150 nm and a length of about 9000 nm. The baked carbon fibers were mixed with potassium hydroxide (purity: 95.0%; manufactured by Toagosei Co., Ltd.) in an amount 4.0 times by mass the amount of fibers, distilled water and ethanol. The mixture was put in a nickel container, and the container was placed in a batch type electric furnace. In the N₂ atmosphere, the temperature was increased to 400° C. at a heating rate of 5° C./min. and maintained for 30 minutes. Subsequently, the temperature was increased to 750° C. and maintained for 15 minutes. Finally, the container was allowed to stand in the furnace until the temperature was 100° C. or less. The container was taken out from the furnace into the air, and 1N-hydrochloric acid was added to the reaction product for neutralization. The neutralized product was washed twice with boiling 0.1N-hydrochloric acid to remove metal impurities. Subsequently, the resultant was washed twice with boiling distilled water to remove the remaining Cl and metal impurities. Finally, hot-air drying was carried out at 110° C., thereby obtaining carbon fibers C.

### Reference Example

### Carbon Fibers B

Vapor-grown carbon fibers produced by a standard method (manufactured by Showa Denko K.K.) were graphitized, thereby obtaining carbon fibers B.

Carbon fibers A: having a peak in the range of 1 to 2 nm in the pore distribution determined by BJH analysis using a nitrogen adsorption method (see FIG. 4); BET specific surface area: 470 m²/g; containing carbon fibers having two or more hollow portions arranged in parallel along the length of the fibers; containing carbon fibers adhering to each other at parts of their surfaces; R value: 1.63; mean fiber diameter: 20 nm; aspect ratio: 500; vapor-grown and activated product.

Carbon fibers B: having no peak in the range of 1 to 2 nm in the pore distribution determined by BJH analysis using a nitrogen adsorption method; BET specific surface area: 12 m²/g; not containing carbon fibers having two or more hollow portions arranged in parallel along the length of the fibers; no adhesion of the fiber surfaces; R value: 1.60; mean fiber diameter: 150 nm; aspect ratio: 67; vapor-grown and graphitized product.

Carbon fibers C: having a peak in the range of 1 to 2 nm in the pore distribution determined by BJH analysis using a nitrogen adsorption method (see FIG. 4); BET specific surface area: 138 m²/g; not containing carbon fibers having two or more hollow portions arranged in parallel along the length of the fibers; no adhesion of the fiber surfaces; R value: 1.32; mean fiber diameter: 150 nm; aspect ratio: 60; vapor-grown, baked and activated product.

The pore volume distribution and BET specific surface area of the carbon fibers were measured using NOVA 1200 (manufactured by Yuasa Ionics Inc.). The pore volume distribution is calculated on the basis of the nitrogen adsorption isotherm. Specifically, nitrogen gas is introduced into a container containing carbon fibers cooled to 77.4 K (boiling point of nitrogen), and at a pressure of P [mmHg] of the introduced nitrogen gas, the amount V [cc/g] of nitrogen gas adsorbed by the carbon fibers is measured by the volume method. Upon plotting the relationship between the relative pressure P/P₀ and the adsorption amount V on the basis of the measured values, nitrogen adsorption isotherm is obtained. P₀ [mmHg] is the saturated vapor pressure of nitrogen gas. The nitrogen gas adsorption isotherm is analyzed by the BJH (Barrett-Joyner-Halenda) method. The BJH method can be carried out according to the process disclosed in the document (J. Amer. Chem. Soc. 73. 373. (1951)).

Moreover, the mean fiber diameter and aspect ratio of the carbon fibers were determined from TEM (transmission electron microscope) micrographs.

### Measurement of Raman Spectrum

Using a Super Labram (manufactured by Dilor), backscattering Raman spectrum was measured at room temperature in the atmosphere under the following conditions: slit width: 100 μm, CCD multichannel detector, light source: Ar⁺ laser (wavelength: 514.5 nm), beam diameter: about 1 μm, optical system: 100 times objective, light source output: 0.1 mW.

### Example 3

### Electric Double Layer Capacitor A

An A1085 aluminum foil having a thickness of 30 μm was prepared. 40 parts by mass of a polymer of cellulose cross-linked with acrylamide (an ion-permeable compound; TG-DTA pyrolysis initiation temperature: 275° C.), 40 parts by mass of acetylene black (carbon fine particles; primary particle diameter: 40 nm), and 20 parts by mass of water were mixed and kneaded to obtain a paste.

Using an applicator (gap: 10 μm), the paste was applied to the aluminum foil by the cast method, followed by drying in air at 180° C. for 3 minutes. Thus, a coating that is conductive adhesive layer containing the ion-permeable compound and the carbon fine particles was formed on the aluminum foil.

In 65 parts by mass of activated carbon A, 5 parts by mass of the carbon fibers A were dispersed so that aggregates having a diameter of 10 μm or more were not formed. A binder and solvent were added thereto and kneaded to obtain a paste.

The paste was applied onto the conductive adhesive layer so that the thickness of the paste after drying was 10 μm, thereby forming a polarizable electrode layer. Thus, a positive polarizable electrode was obtained. The sum total of BET specific surface areas of the activated carbon A and the carbon fibers A is 2479 (=2009+470) m²/g.

In 65 parts by mass of activated carbon B, 5 parts by mass of the carbon fibers B were dispersed so that aggregates having a diameter of 10 μm or more were not formed. A binder and solvent were added thereto and kneaded to obtain a paste.

The paste was applied onto the conductive adhesive layer so that the thickness of the paste after drying was 10 μm, thereby forming a polarizable electrode layer. Thus, a negative polarizable electrode was obtained. The sum total of BET specific surface areas of the activated carbon B and the carbon fibers B is 1857 (=1845+12) m²/g.

Each of the positive and negative polarizable electrodes was cut into a size of 30 mm×40 mm. A separator (glass fiber paper TGP008A, film thickness: 80 μm; manufactured by Nippon Sheet Glass Co., Ltd.) was laminated between the positive and negative polarizable electrodes, and two single cells were obtained. The two single cells were connected in parallel and placed in an aluminum container having outer size of 35 mm×45 mm×1.3 mm, and an electrolyte solution in which tetraethylmethylammonium=tetrafluoroborate (TEMA/BF4) was dissolved in propylene carbonate (PC) at a concentration of 1.4 mol/l was poured. The aluminum container was sealed by sealing the lid sealing part with polyether ether ketone resin (PEEK), thereby obtaining a square-shaped electric double layer capacitor.

Using a charge-discharge test instrument (HJ-101SM6; produced by Hokuto Denko Co.), the capacitor was charged to 2.6 V under the conditions where the temperature was 25° C. and the charge rates were 0.5 mA, 5 mA, 50 mA, and 500 mA, and then discharged. The capacitance (mF/cell) and impedance (mΩ[measurement frequency: 1 kHz]) were measured at this time.

Moreover, the capacitor was charged to 2.6 V under the conditions where the temperature was −40° C. and the charge rate was 50 mA, and then discharged. The capacitance (mF/cell) and impedance (mΩ[measurement frequency: 1 kHz]) were measured at this time. Table 1 shows the results.

The impedance was measured using an KCR HiTester (model: 3532; manufactured by HIOK).

TABLE 1

| | | Ex. | | | Comp. Ex. | | | | |
|---|---|---|---|---|---|---|---|---|---|
| | | 3 | 4 | 5 | 1 | 2 | 3 | 4 | 5 |
| Positive | Activated | A | A | A | A | C | A | D | E |
| electrode | carbon | | | | | | | | |
| | Carbon | A | C | C | B | B | — | — | B |
| | fiber | | | | | | | | |
| Negative | Activated | B | B | B | A | C | A | D | E |
| electrode | carbon | | | | | | | | |
| | Carbon | B | B | B | B | B | — | — | B |
| | fiber | | | | | | | | |

| | | | | | | | | |
|---|---|---|---|---|---|---|---|---|
| Electrolyte solution | TEMA | TEMA | TEMA | TEMA | TEMA | TEMA | TEMA | TEMA |
| | BF4 | BF4 | BF4 | BF4 | BF4 | BF4 | BF4 | BF4 |
| | PC | PC | PC | PC | PC | PC | PC | PC |
| | 1.4 M/L | 1.4 M/L | 1.4 M/L | 1.4 M/L | 1.4 M/L | 1.4 M/L | 1.4 M/L | 1.4 M/L |

25° C.

| | | | | | | | | | | |
|---|---|---|---|---|---|---|---|---|---|---|
| Capacitance(mF) | 0.5 | mA | 490 | 407 | 421 | 277 | 428 | 365 | 316 | 370 |
| | 5 | mA | 477 | 397 | 411 | 277 | 429 | 357 | 308 | 362 |
| | 50 | mA | 463 | 389 | 402 | 272 | 420 | 337 | 293 | 347 |
| | 500 | mA | 413 | 374 | 394 | 248 | 367 | 309 | — | 318 |
| Impedance(mΩ) | 0.5 | mA | 0.003 | 0.002 | 0.004 | 0.016 | 0.002 | 0.003 | 0.004 | 0.003 |
| | 5 | mA | 0.003 | 0.002 | 0.004 | 0.016 | 0.002 | 0.003 | 0.004 | 0.003 |
| | 50 | mA | 0.003 | 0.002 | 0.005 | 0.016 | 0.002 | 0.003 | 0.004 | 0.003 |
| | 500 | mA | 0.003 | 0.004 | 0.007 | 0.026 | 0.026 | 0.004 | — | 0.007 |

−40° C.

| | | | | | | | | | | |
|---|---|---|---|---|---|---|---|---|---|---|
| Capacitance(mF) | 50 | mA | 436 | 359 | 337 | — | 349 | — | — | — |
| Impedance(mΩ) | 50 | mA | 0.005 | 0.002 | 0.005 | — | 0.011 | 0.011 | — | — |

### Examples 4 to 5, and Comparative Examples 1 to 5

Electric double layer capacitors were obtained in the same manner as in Example 3 except that the activated carbon and carbon fibers were replaced by those indicated in Table 1. Table 1 shows the evaluation results of these capacitors.

As is clear from Table 1, the electric double layer capacitors of Comparative Examples 1 and 3 to 5 have a low capacitance and a high impedance. In the electric double layer capacitor of Comparative Example 2, the impedance is high during rapid charging at a high current, and the capacitance is low and the impedance is high at the low temperature.

In contrast, the electric double layer capacitors of the present invention have a high capacitance at the low and high temperatures, and also maintain the impedance low during rapid charging at a high current.

### REFERENCE SIGNS LIST

1, 2: Carbon fibers
3: Hollow portion
4: Adhering portion

1. An electric double layer capacitor comprising:
a positive polarizable electrode comprising a positive polarizable electrode layer containing carbon fibers P and activated carbon P, and a negative polarizable electrode comprising a negative polarizable electrode layer containing carbon fibers N and activated carbon N,
wherein at least one of the carbon fibers P and carbon fibers N has at least one peak in the range of 1 to 2 nm in a pore distribution determined by BJH analysis using a nitrogen adsorption method; and
the sum of BET specific surface areas of the activated carbon P and the carbon fibers P is larger than the sum of BET specific surface areas of the activated carbon N and the carbon fibers N.

2. The electric double layer capacitor according to claim 1, wherein the BET specific surface area of the activated carbon P is larger than the BET specific surface area of the activated carbon N; and
the BET specific surface area of the carbon fibers P is larger than the BET specific surface area of the carbon fibers N.

3. The electric double layer capacitor according to claim 1, wherein the carbon fibers P have at least one peak in the range of 1 to 2 nm in a pore distribution determined by BJH analysis using a nitrogen adsorption method.

4. The electric double layer capacitor according to claim 1, wherein the carbon fibers P and/or carbon fibers N include those that adhere to each other at least at parts of their surfaces.

5. The electric double layer capacitor according to claim 1, wherein the carbon fibers P and/or carbon fibers N include those that have two or more hollow portions.

6. The electric double layer capacitor according to claim 1, wherein the carbon fibers P and/or carbon fibers N include those that have two or more hollow portions arranged in parallel along the length of the fibers.

7. The electric double layer capacitor according to claim 1, wherein the carbon fibers P and/or carbon fibers N are 1 to 2 in an R value of Raman spectrum.

8. The electric double layer capacitor according to claim 1, wherein the carbon fibers P and/or carbon fibers N have a BET specific surface area of 30 to 1000 m²/g, a mean fiber diameter of 1 to 500 nm, and an aspect ratio of 10 to 15000.

9. The electric double layer capacitor according to claim 1, wherein the sum of BET specific surface areas of the activated carbon P and the carbon fibers P is 1800 to 2600 m²/g; and the sum of BET specific surface areas of the activated carbon N and the carbon fibers N is 1500 to 2100 m²/g.

10. The electric double layer capacitor according to claim 1, wherein the activated carbon P and/or activated carbon N have the highest peak a of pore volume in a pore size range of 0.6 to 0.8 nm in a pore volume distribution determined by an HK analysis using Argon adsorption isotherm, the value of the peak a being in the range of 0.08 to 0.11 cm³/g and being 8 to 11% of the total pore volume; and the activated carbon P and/or activated carbon N have a BET specific surface area of 1700 to 2200 m²/g.

11. (canceled)

12. The electric double layer capacitor according to claim 1, wherein the amount of the carbon fibers P is 0.1 to 20% by mass based on the amount of the activated carbon P; and the amount of the carbon fibers N is 0.1 to 20% by mass based on the amount of the activated carbon N.

13-19. (canceled)

20. Carbon fibers which have at least one peak in the range of 1 to 2 nm in a pore distribution determined by BJH analysis using a nitrogen adsorption method.

21. The carbon fibers according to claim 20, which include those that adhere to each other at least at parts of their surfaces.

22. The carbon fibers according to claim 20, which include those that have two or more hollow portions.

23. The carbon fibers according to claim 20, which include those that have two or more hollow portions arranged in parallel along the length of the fibers.

24. The carbon fibers according to claim 20, which have an R value of Raman spectrum of 1 to 2.

25. The carbon fibers according to claim 20, which have a BET specific surface area of 30 to 1000 m²/g, a mean fiber diameter of 1 to 500 nm, and an aspect ratio of 10 to 15000.

26. A carbon composite comprising activated carbon and the carbon fibers according to claim 20.

27. A carbon composite comprising activated carbon and the carbon fibers according to claim 20, wherein the activated carbon has the highest peak a of pore volume in a pore size range of 0.6 to 0.8 nm in a pore volume distribution determined by an HK analysis using Argon adsorption isotherm, the value of the peak a being in the range of 0.08 to 0.11 cm³/g and being 8 to 11% of the total pore volume; and the activated carbon has a BET specific surface area of 1700 to 2200 m²/g.

28. A polarizable electrode comprising activated carbon and the carbon fibers according to claim 20.

29. A polarizable electrode comprising the carbon composite according to claim 26.

30. An energy device comprising the electric double layer capacitor according to claim 1.

31-35. (canceled)

36. An electrical or electronic equipment comprising the energy device according to claim 30.

37. A vehicle comprising the energy device according to claim 30.
